(19) United States
(12) Patent Application Publication
(10) Pub. No.: US 2016/0234722 A1
(43) Pub. Date: Aug. 11, 2016

(54) SELECTIVELY IGNORING RLC ERRORS DURING HANDOVER

(71) Applicant: QUALCOMM INCORPORATED, San Diego, CA (US)

(72) Inventors: Huan XU, San Diego, CA (US); Tim Tynghuei LIOU, San Diego, CA (US); Xuepan GUAN, Beijing (CN)

(73) Assignee: QUALCOMM INCORPORATED, San Diego, CA (US)

(21) Appl. No.: 15/022,200

(22) PCT Filed: Oct. 25, 2013
(86) PCT No.: PCT/CN2013/085954

§ 371 Date: Mar. 15, 2016

(51) Int. Cl. H04W 36/00

(52) U.S. Cl. CPC H04W 36/0011

(57) ABSTRACT

A method, an apparatus, and a computer program product for wireless communication are provided. The method comprises: receiving a message at a user equipment (UE) from a source base station connected to a first radio network controller to relocate to a target base station connected to a second network controller different from the first network controller; detecting an unrecoverable Radio Link Control (RLC) error at the UE; and ignoring the RLC unrecoverable error when it occurs after receiving the message to relocate while the UE is still connected to the source base station, before relocation is completed, and proceeding to relocate to the target base station. Various alterations and embodiments are disclosed.

### BACKGROUND

1. Field

Aspects of the present disclosure relate generally to wireless communication systems, and more particularly, to avoiding call drop during caused by RLC (radio link control) failure during handover between cells controlled by independent RNSs (Radio Network Subsystems) in a TD-SCDMA network.

2. Background

Wireless communication networks are widely deployed to provide various communication services such as telephony, video, data, messaging, broadcasts, and so on. Such networks, which are usually multiple access networks, support communications for multiple users by sharing the available network resources. One example of such a network is the Universal Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). For example, China is pursuing TD-SCDMA as the underlying air interface in the UTRAN architecture with its existing GSM infrastructure as the core network. The UMTS also supports enhanced 3G data communications protocols, such as High Speed Packet Access (HSPA), which provides higher data transfer speeds and capacity to associated UMTS networks. HSPA is a collection of two mobile telephony protocols, High Speed Downlink Packet Access (HSDPA) and High Speed Uplink Packet Access (HSUPA), that extends and improves the performance of existing wideband protocols.

As the demand for mobile broadband access continues to increase, research and development continue to advance the UMTS technologies not only to meet the growing demand for mobile broadband access, but to advance and enhance the user experience with mobile communications.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 is a block diagram conceptually illustrating an example of a telecommunications system.

FIG. 2 is a block diagram conceptually illustrating an example of a frame structure in a telecommunications system.

FIG. 3 is a block diagram conceptually illustrating an example of a node B in communication with a UE in a telecommunications system.

FIG. 4 illustrates an example of network coverage areas.

FIG. 5 is a block diagram conceptually illustrating an example of a handover of a UE between cells with different controllers in a telecommunications system.

FIG. 6 illustrates an example flow diagram for a handover between cells with different controllers.

FIG. 7 illustrates a method for UE handover between cells with different controllers, where the source controller signals an unrecoverable error.

FIG. 8 is a diagram illustrating an example of a hardware implementation for an apparatus employing a processing system.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

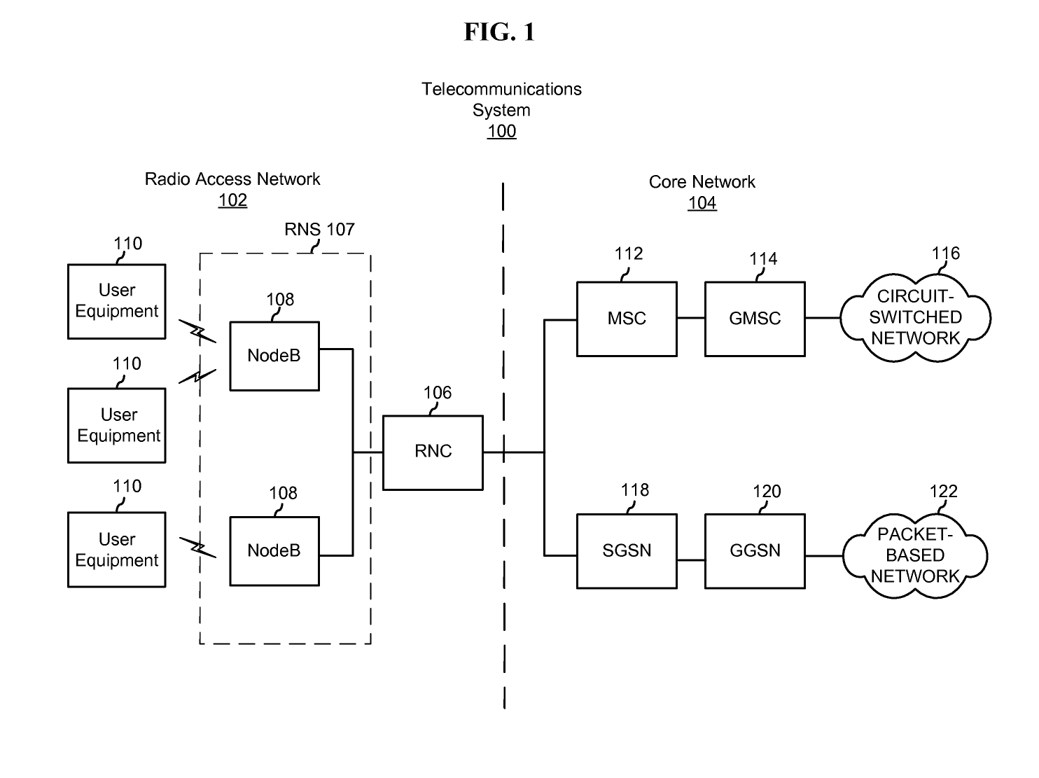

Turning now to FIG. 1, a block diagram is shown illustrating an example of a telecommunications system 100. The various concepts presented throughout this disclosure may be implemented across a broad variety of telecommunication systems, network architectures, and communication standards. By way of example and without limitation, the aspects of the present disclosure illustrated in FIG. 1 are presented with reference to a UMTS system employing a TD-SCDMA standard. In this example, the UMTS system includes a (radio access network) RAN 102 (e.g., UTRAN) that provides various wireless services including telephony, video, data, messaging, broadcasts, and/or other services. The RAN 102 may be divided into a number of Radio Network Subsystems (RNSs) such as an RNS 107, each controlled by a Radio Network Controller (RNC) such as an RNC 106. For clarity, only the RNC 106 and the RNS 107 are shown; however, the RAN 102 may include any number of RNCs and RNSs in addition to the RNC 106 and RNS 107. The RNC 106 is an apparatus responsible for, among other things, assigning, reconfiguring and releasing radio resources within the RNS 107. The RNC 106 may be interconnected to other RNCs (not shown) in the RAN 102 through various types of interfaces such as a direct physical connection, a virtual network, or the like, using any suitable transport network.

The geographic region covered by the RNS 107 may be divided into a number of cells, with a radio transceiver apparatus serving each cell. A radio transceiver apparatus is commonly referred to as a node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, two node Bs 108 are shown; however, the RNS 107 may include any number of wireless node Bs. The node Bs 108 provide wireless access points to a core network 104 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. For illustrative purposes, three UEs 110 are shown in communication with the node Bs 108. The downlink (DL), also called the forward link, refers to the communication link from a node B to a UE, and the uplink (UL), also called the reverse link, refers to the communication link from a UE to a node B.

The core network 104, as shown, includes a GSM core network. However, as those skilled in the art will recognize, the various concepts presented throughout this disclosure may be implemented in a RAN, or other suitable access network, to provide UEs with access to types of core networks other than GSM networks.

In this example, the core network 104 supports circuit-switched services with a mobile switching center (MSC) 112 and a gateway MSC (GMSC) 114. One or more RNCs, such as the RNC 106, may be connected to the MSC 112. The MSC 112 is an apparatus that controls call setup, call routing, and UE mobility functions. The MSC 112 also includes a visitor location register (VLR) (not shown) that contains subscriber-related information for the duration that a UE is in the coverage area of the MSC 112. The GMSC 114 provides a gateway through the MSC 112 for the UE to access a circuit-switched network 116. The GMSC 114 includes a home location register (HLR) (not shown) containing subscriber data, such as the data reflecting the details of the services to which a particular user has subscribed. The HLR is also associated with an authentication center (AuC) that contains subscriber-specific authentication data. When a call is received for a particular UE, the GMSC 114 queries the HLR to determine the UE's location and forwards the call to the particular MSC serving that location.

The core network 104 also supports packet-data services with a serving GPRS support node (SGSN) 118 and a gateway GPRS support node (GGSN) 120. GPRS, which stands for General Packet Radio Service, is designed to provide packet-data services at speeds higher than those available with standard GSM circuit-switched data services. The GGSN 120 provides a connection for the RAN 102 to a packet-based network 122. The packet-based network 122 may be the Internet, a private data network, or some other suitable packet-based network. The primary function of the GGSN 120 is to provide the UEs 110 with packet-based network connectivity. Data packets are transferred between the GGSN 120 and the UEs 110 through the SGSN 118, which performs primarily the same functions in the packet-based domain as the MSC 112 performs in the circuit-switched domain.

The UMTS air interface is a spread spectrum Direct-Sequence Code Division Multiple Access (DS-CDMA) system. The spread spectrum DS-CDMA spreads user data over a much wider bandwidth through multiplication by a sequence of pseudorandom bits called chips. The TD-SCDMA standard is based on such direct sequence spread spectrum technology and additionally calls for a time division duplexing (TDD), rather than a frequency division duplexing (FDD) as used in many FDD mode UMTS/W-CDMA systems. TDD uses the same carrier frequency for both the uplink (UL) and downlink (DL) between a node B 108 and a UE 110, but divides uplink and downlink transmissions into different time slots in the carrier.

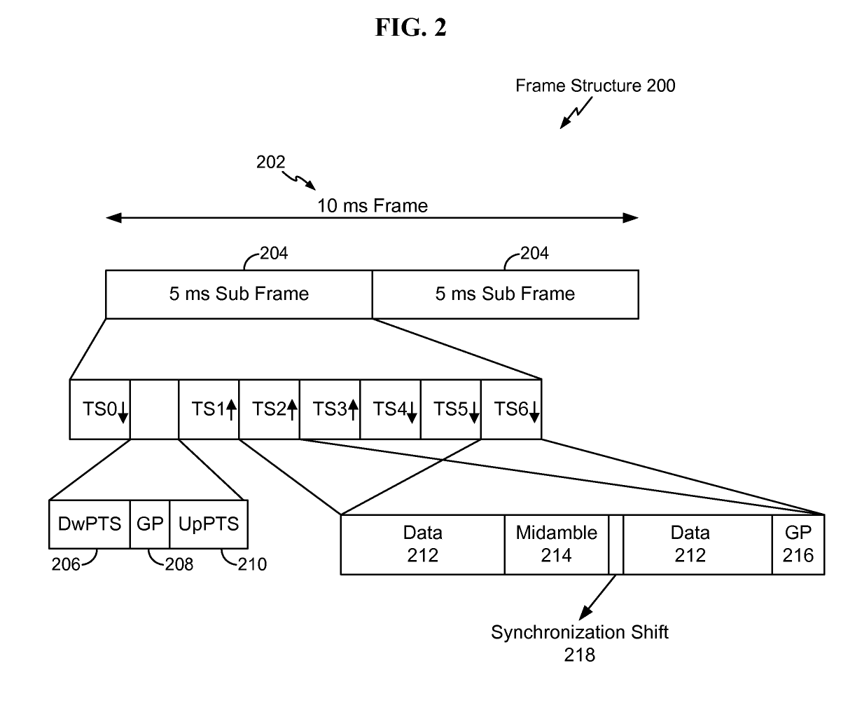

FIG. 2 shows a frame structure 200 for a TD-SCDMA carrier. The TD-SCDMA carrier, as illustrated, has a frame 202 that is 10 ms in length. The chip rate in TD-SCDMA is 1.28 Mcps. The frame 202 has two 5 ms subframes 204, and each of the subframes 204 includes seven time slots, TS0 through TS6. The first time slot, TS0, is usually allocated for downlink communication, while the second time slot, TS1, is usually allocated for uplink communication. The remaining time slots, TS2 through TS6, may be used for either uplink or downlink, which allows for greater flexibility during times of higher data transmission times in either the uplink or downlink directions. A downlink pilot time slot (DwPTS) 206, a guard period (GP) 208, and an uplink pilot time slot (UpPTS) 210 (also known as the uplink pilot channel (UpPCH)) are located between TS0 and TS1. Each time slot, TS0-TS6, may allow data transmission multiplexed on a maximum of 16 code channels. Data transmission on a code channel includes two data portions 212 (each with a length of 352 chips) separated by a midamble 214 (with a length of 144 chips) and followed by a guard period (GP) 216 (with a length of 16 chips). The midamble 214 may be used for features, such as channel estimation, while the guard period 216 may be used to avoid inter-burst interference. Also transmitted in the data portion is some Layer 1 control information, including Synchronization Shift (SS) bits 218. Synchronization Shift bits 218 only appear in the second part of the data portion. The Synchronization Shift bits 218 immediately following the midamble can indicate three cases: decrease shift, increase shift, or do nothing in the upload transmit timing. The positions of the SS bits 218 are not generally used during uplink communications.

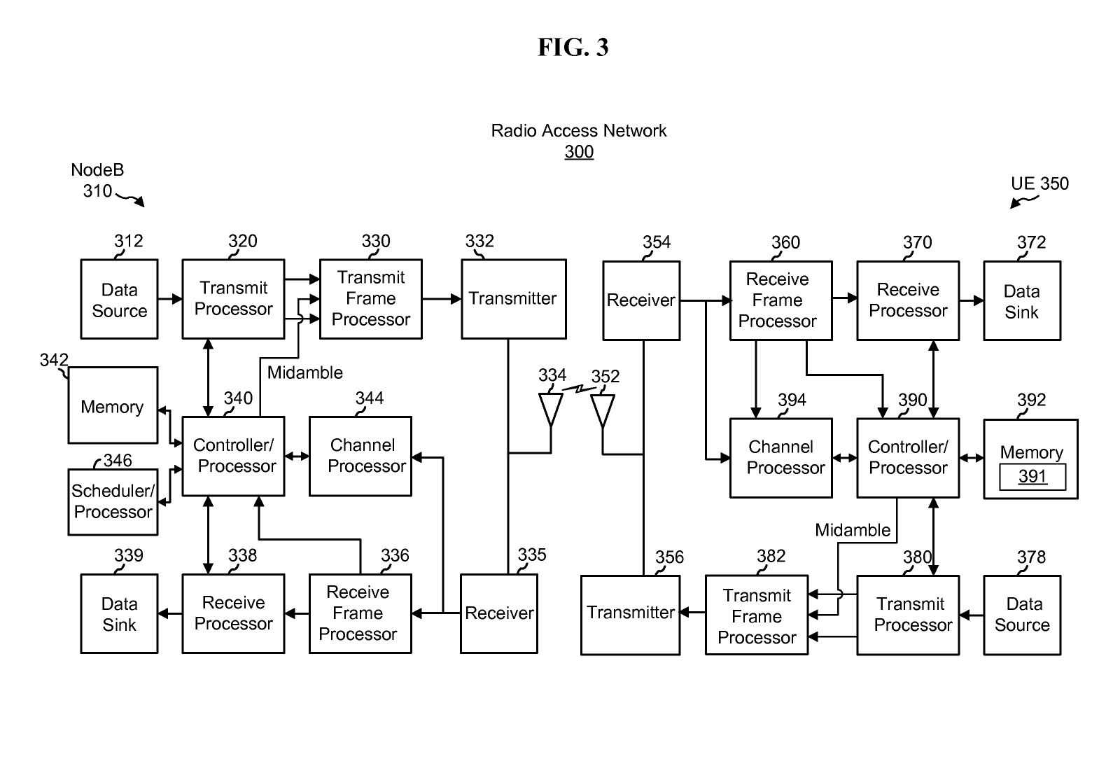

FIG. 3 is a block diagram of a node B 310 in communication with a UE 350 in a RAN 300, where the RAN 300 may be the RAN 102 in FIG. 1, the node B 310 may be the node B 108 in FIG. 1, and the UE 350 may be the UE 110 in FIG. 1. In the downlink communication, a transmit processor 320 may receive data from a data source 312 and control signals from a controller/processor 340. The transmit processor 320 provides various signal processing functions for the data and control signals, as well as reference signals (e.g., pilot signals). For example, the transmit processor 320 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 344 may be used by a controller/processor 340 to determine the coding, modulation, spreading, and/or scrambling schemes for the transmit processor 320. These channel estimates may be derived from a reference signal transmitted by the UE 350 or from feedback contained in the midamble 214 (FIG. 2) from the UE 350. The symbols generated by the transmit processor 320 are provided to a transmit frame processor 330 to create a frame structure. The transmit frame processor 330 creates this frame structure by multiplexing the symbols with a midamble 214 (FIG. 2) from the controller/processor 340, resulting in a series of frames. The frames are then provided to a transmitter 332, which provides various signal conditioning functions including amplifying, filtering, and modulating the frames onto a carrier for downlink transmission over the wireless medium through smart antennas 334. The smart antennas 334 may be implemented with beam steering bidirectional adaptive antenna arrays or other similar beam technologies.

At the UE 350, a receiver 354 receives the downlink transmission through an antenna 352 and processes the transmission to recover the information modulated onto the carrier. The information recovered by the receiver 354 is provided to a receive frame processor 360, which parses each frame, and provides the midamble 214 (FIG. 2) to a channel processor 394 and the data, control, and reference signals to a receive processor 370. The receive processor 370 then performs the inverse of the processing performed by the transmit processor 320 in the node B 310. More specifically, the receive processor 370 descrambles and despreads the symbols, and then determines the most likely signal constellation points transmitted by the node B 310 based on the modulation scheme. These soft decisions may be based on channel estimates computed by the channel processor 394. The soft decisions are then decoded and deinterleaved to recover the data, control, and reference signals. The CRC codes are then checked to determine whether the frames were successfully decoded. The data carried by the successfully decoded frames will then be provided to a data sink 372, which represents applications running in the UE 350 and/or various user interfaces (e.g., display). Control signals carried by successfully decoded frames will be provided to a controller/processor 390. When frames are unsuccessfully decoded by the receiver processor 370, the controller/processor 390 may also use an acknowledgement (ACK) and/or negative acknowledgement (NACK) protocol to support retransmission requests for those frames.

In the uplink, data from a data source 378 and control signals from the controller/processor 390 are provided to a transmit processor 380. The data source 378 may represent applications running in the UE 350 and various user interfaces (e.g., keyboard). Similar to the functionality described in connection with the downlink transmission by the node B 310, the transmit processor 380 provides various signal processing functions including CRC codes, coding and interleaving to facilitate FEC, mapping to signal constellations, spreading with OVSFs, and scrambling to produce a series of symbols. Channel estimates, derived by the channel processor 394 from a reference signal transmitted by the node B 310 or from feedback contained in the midamble transmitted by the node B 310, may be used to select the appropriate coding, modulation, spreading, and/or scrambling schemes. The symbols produced by the transmit processor 380 will be provided to a transmit frame processor 382 to create a frame structure. The transmit frame processor 382 creates this frame structure by multiplexing the symbols with a midamble 214 (FIG. 2) from the controller/processor 390, resulting in a series of frames. The frames are then provided to a transmitter 356, which provides various signal conditioning functions including amplification, filtering, and modulating the frames onto a carrier for uplink transmission over the wireless medium through the antenna 352.

The uplink transmission is processed at the node B 310 in a manner similar to that described in connection with the receiver function at the UE 350. A receiver 335 receives the uplink transmission through the antenna 334 and processes the transmission to recover the information modulated onto the carrier. The information recovered by the receiver 335 is provided to a receive frame processor 336, which parses each frame, and provides the midamble 214 (FIG. 2) to the channel processor 344 and the data, control, and reference signals to a receive processor 338. The receive processor 338 performs the inverse of the processing performed by the transmit processor 380 in the UE 350. The data and control signals carried by the successfully decoded frames may then be provided to a data sink 339 and the controller/processor, respectively. If some of the frames were unsuccessfully decoded by the receive processor, the controller/processor 340 may also use an acknowledgement (ACK) and/or negative acknowledgement (NACK) protocol to support retransmission requests for those frames.

The controller/processors 340 and 390 may be used to direct the operation at the node B 310 and the UE 350, respectively. For example, the controller/processors 340 and 390 may provide various functions including timing, peripheral interfaces, voltage regulation, power management, and other control functions. The computer readable media of memories 342 and 392 may store data and software for the node B 310 and the UE 350, respectively. For example, the memory 392 of the UE 350 may store a radio link control (RLC) error-handling module 391 which, when executed by the controller/processor 390, configures the UE 350 ignore RLC unrecoverable errors if the error is received during handover between two cells with different radio network controllers. A scheduler/processor 346 at the node B 310 may be used to allocate resources to the UEs and schedule downlink and/or uplink transmissions for the UEs.

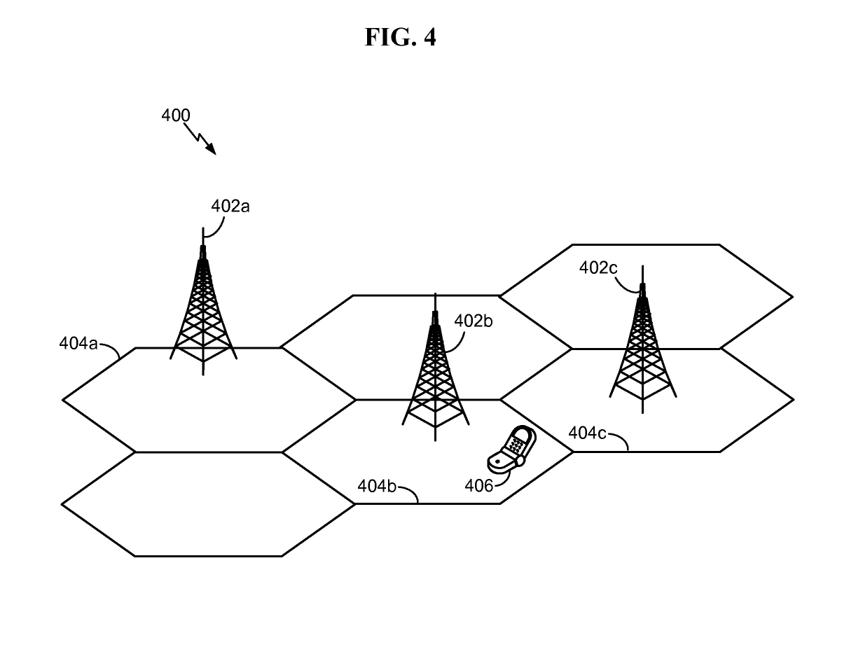

Some base stations in a network may cover only a portion of a geographical area. FIG. 4 illustrates coverage of a network, such as a TD-SCDMA network, as represented by individual base stations. A geographical area 400 may include multiple TD-SCDMA base stations, illustrated by towers 402a, 402b, and 402c, each serving their own respective geographic locations, illustrated by geographic cells 404a, 404b, and 404c, respectively. A user equipment (UE) 406 may move from one cell, such as cell 404a, to another cell, such as a cell 404b. The movement of the UE 406 may specify a handover or a cell reselection. The different base stations may be coordinated through a single radio network controller (RNC) or through different RNCs. If the base stations are controlled by different RNCs, they may be considered to be on different subsystems.

### Selectively Ignoring RLC Errors During Handover

When a user equipment (UE) is in the midst of handover (also called relocation) from a source cell tower to a target cell tower on separate subsystems (e.g., cell towers linked to independent radio network controllers) and the radio link control (RLC) layer at the UE side triggers an unrecoverable error as a result of the RLC state (e.g., the number of simultaneously open uplink transmission channels reaches or exceeds a maximum limit), the conventional recovery procedure (e.g., initiating a Cell Update procedure) results in a call drop. However, because the cell towers are on separate systems, an error when the UE is still under control of the originating source radio network controller does not necessarily mean that there is anything wrong at the destination radio network controller. Therefore, when the unrecoverable error is triggered while the UE is still under control of source radio network controller after handover has begun, the UE may ignore the error and continue to establish the call with the target tower.

Statistically, this should result in fewer dropped calls. Specifically, if the UE responds in the conventional manner to the unrecoverable error triggered under source radio network controller, the call will be dropped. However, if the UE ignores the error and proceeds to establish the call with the target radio network controller, the call may not be dropped unless the UE is unable to complete the handover to the target tower.

Specifically, to avoid the dropping of an ongoing call and to reduce the service interruption caused by a RLC (Radio Link Control) unrecoverable error of the UE during a SRNS (Source Radio Network Subsystem) relocation procedure, RLC unrecoverable errors triggered when UE is under control of the source radio network controller may be ignored.

Operations within network devices such as UEs are partitioned into a stack of abstraction “layers,” with higher level layers communicating through intermediate layers to lower level layers. An example of low-level layer responsibilities includes control of the radio receiver 354 and transmitter 356 used to connect to the network. Higher up is a Media Access Control (MAC) layer that handles data communications protocols. Radio Link Control may be handled by a layer above MAC, and above that may be a Radio Resource Control (RRC) layer. Among other things, the RRC layer offers services to upper layers such as general control of radio resources, notifications, and dedicated control services. The RRC layer provides the UE-UTRAN portion of signaling connections to the upper layers to support the exchange of upper layer's information flow. The signaling connection is used between the user equipment and the core network to transfer upper layer information. From an implementation point of view, a decision to ignore and/or not report the RLC error detected by the RLC layer may be made at an RLC layer level. If the RLC error is reported to a higher-level layer such as the RRC layer, the RRC layer may make the decision not to trigger the conventional recovery procedure.

The conventional procedure for a UE to perform handover from a source Radio Network Subsystem to a target Radio Network Subsystem in UMTS is defined as Source Radio Network Subsystem (SRNS) relocation. Per a 3GPP technical specification requirement (3GPP TS 25.331), in Acknowledged Mode (AM) when there is a Radio Link Control unrecoverable error reported to a higher layer of the UE (such as the Radio Resource Control layer) during SRNS relocation procedure, the UE is required to send a Cell Update or go to Idle, depending upon stage the SRNS (Source Radio Network Subsystem) stage. In either case, a call drop (for a Circuit Switched/Packet Switched call) or service interruption is unavoidable.

As described in the 3GPP standard (25.331), the UE needs to perform re-establishment of the Radio Link Control Acknowledged Mode entity (RLC AM entity) for all active Signaling Radio Bearers (SRBs, available for transmission of Radio Resource Control messages) as well as for user Radio Bearers (RBs, such as the RB for packet-switched data service) during the SRNS relocation pending state.

The SRNS “relocation pending state” is defined as from when the UE receives the SRNS relocation message sent by the network, to when a SRNS relocation complete message gets acknowledged by the network.

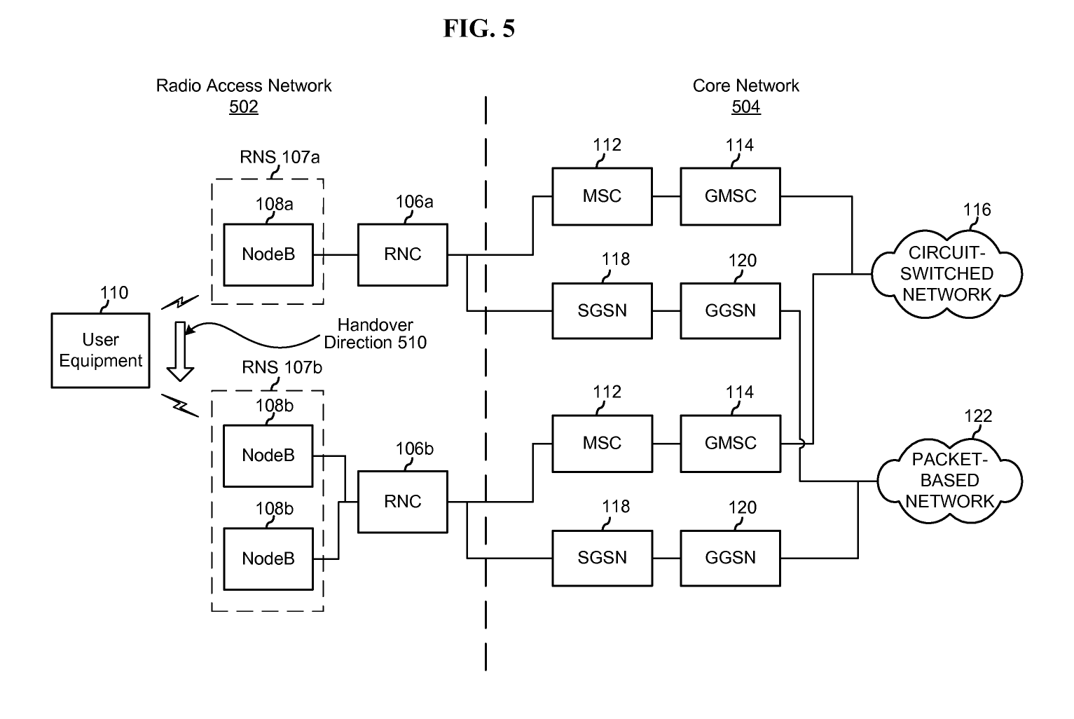

FIG. 5 illustrates a telecommunications system where the radio access network 502 contains more than one Radio Network Controller (RNC). The RNCs may be connected to different portions of the core network 504 (as shown), or may connect to the same core network 504 components. As illustrated, a UE 110 is established on a NodeB 108a of a first Radio Network Subsystem 107a controlled by a first RNC 106a. A handover of the UE 110 to a second Radio Network Subsystem 107b is initiated (SRNS relocation), is shown by handover direction 510. The second RNC 106b of the second Radio Network Subsystem is independent of the first “source” RNC 106a.

If an RLC unrecoverable error is reported during the SRNS pending state, it usually occurs while the UE 110 is still linked to a source Radio Network Controller 106a. However, the new target RNC (Radio Network Controller 106b) will communicate with UE 110 based on a newly re-established RLC AM (Radio Link Control Acknowledge Mode) entity. If the UE is in communication with the target RNC 106b, the UE 110 may safely ignore RLC (Radio Link Control) errors from the source RNC 106a and thus the UE may not initiate Cell Update procedure or go to Idle during SRNS (Source Radio Network Subsystem) pending state as would otherwise be called for as a result of the source RNC RLC error.

In other words, during the SRNS (Source Radio Network Subsystem) relocation state, the UE 110 ignores the RLC error indication originated from the source RNC 106a and continues the SRNS relocation procedure to handover to the target RNC 106b. The RLC error does not apply to the new target radio network controller after SRNS procedure is complete, when the RLC re-establishment is finished per the conventional 3GPP procedure. In this case, there is a high probability that the new RNC 106b will resume the service to the UE 110, thereby reducing the call drop rate.

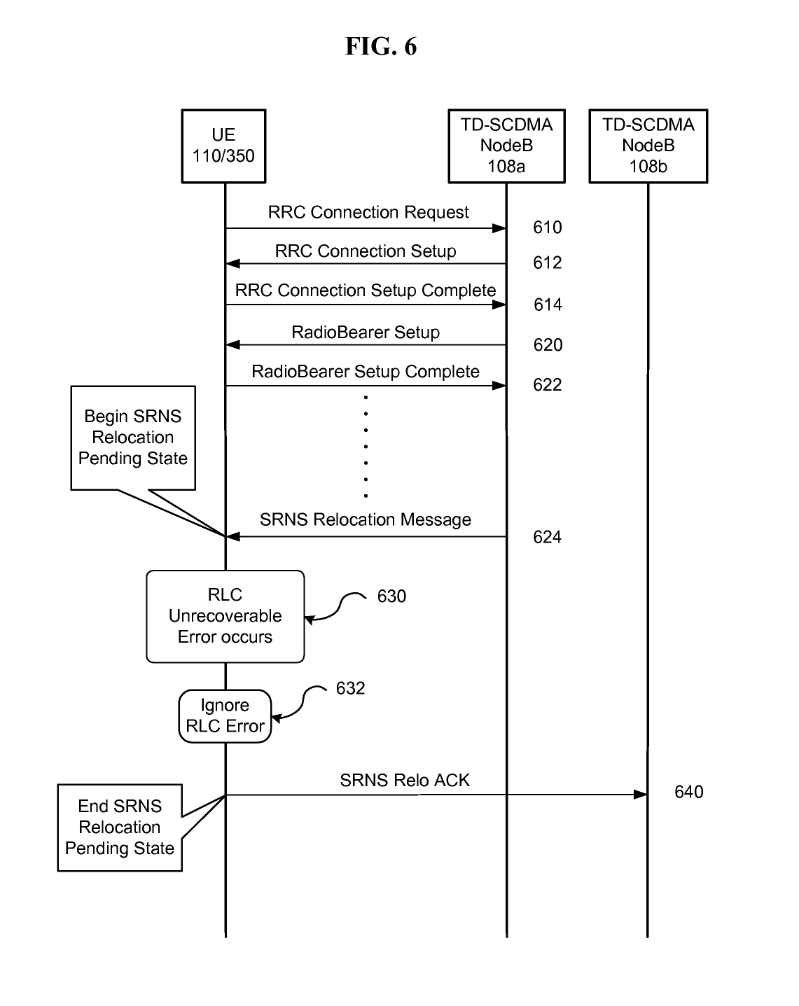

FIG. 6 is an example flow diagram of a SRNS relocation (i.e., handover) between cells with different RNCs. At the RRC layer level, a call is setup with the first “source” NodeB 108a, which includes the UE 110/350 sending the source NodeB 108a an RRC Connection Request 610, receiving the RRC Connection Setup message 612 in response, and then sending an RRC Connection Setup Complete message 614. There is radio bearer setup 620 for a circuit switched or packet switched service call sent from the source NodeB 108a to the UE 110/350. The UE 110/350 responds with a radio bearer setup complete message 622.

After the call is established with the first NodeB 108a, the UE 110/350 receives a SRNS relocation message 624 from the source NodeB 108a, which demarcates the beginning of the SRNS Relocation Pending state for the UE.

At some point after the SRNS Relocation Pending state begins, an RLC unrecoverable error occurs at the UE side 630 and the RLC layer at UE 110/350 triggers an RLC Unrecoverable Error message. Rather than acting on the error message, the UE 110/350 ignores it (632), proceeding with the SRNS relocation. The UE 110/350 transmits a SRNS Relocation acknowledgement (ACK) message 640 to the second “target” NodeB 108b and the SRNS Relocation is complete, marking the end of the SRNS Relocation Pending State and resulting in the UE now connected to the target NodeB 108b.

The call might be dropped if, for example, any previous RLC transmission finally hits the unrecoverable error during SRNS relocation pending state, when UE 110/350 is still under source RNC's control. But because the RLC Error 630 originates with the source RNC 106a for the source NodeB 108a, an error relating to the source RNC 106a does not necessarily mean there is anything wrong at the target RNC 106b of the target NodeB 108b. Thus the UE may continue to connect to the target RNC 108b and avoid call-drop.

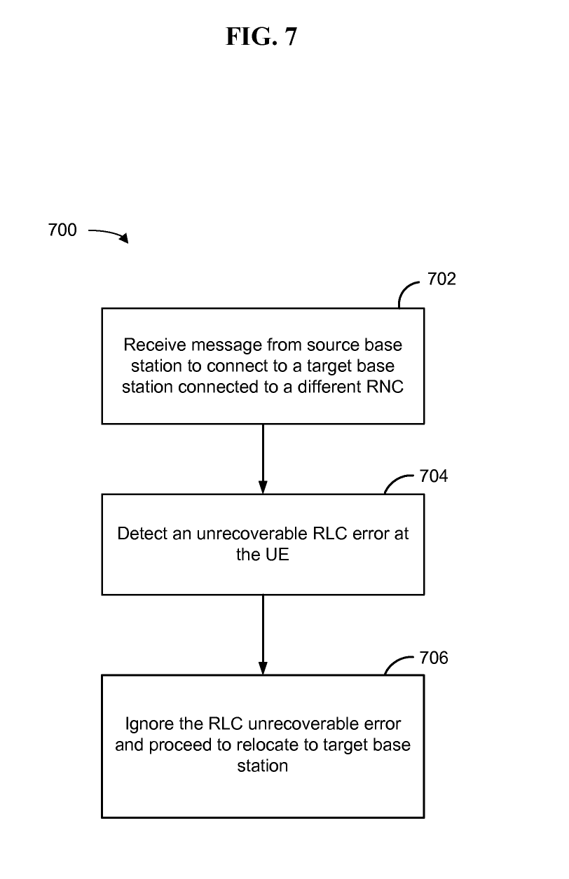

FIG. 7 shows an example of a wireless communication method 700 that may be used by the controller/processor 390 of the UE 110/350 to avoid a dropped call when a source RNC 106a reports a RLC unrecoverable error during SRNS relocation. A UE receives a message from a source base station to connect to a target base station connected to a different RNC, as shown in block 702. The UE 110/350 detects an unrecoverable RLC error, as shown in block 704. If the RLC error is detected after receiving the message to relocate while the UE is still connected to the source base station, before relocation is completed, then instead of following conventional protocol, the UE110/350 ignores the RLC unrecoverable error and proceeds to relocate to the target base station/RNS, as shown in block 706.

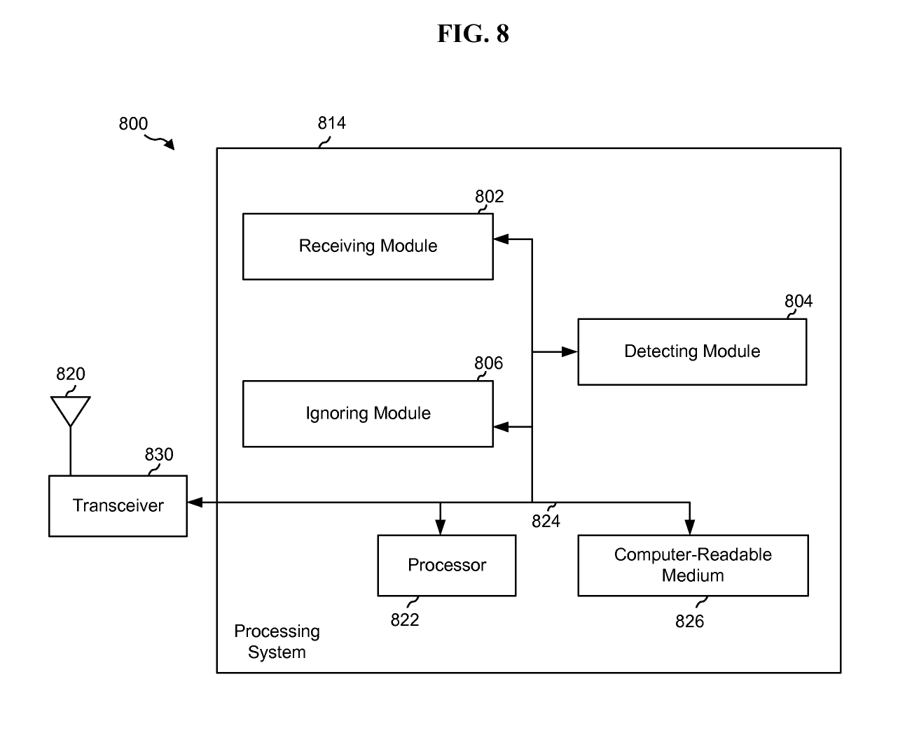

FIG. 8 is a diagram illustrating an example of a hardware implementation for an apparatus 800 employing a processing system 814. Apparatus 800 may be, for example, UE 110/350 The processing system 814 may be implemented with a bus architecture, represented generally by the bus 824. The bus 824 may include any number of interconnecting buses and bridges depending on the specific application of the processing system 814 and the overall design constraints. The bus 824 links together various circuits including one or more processors and/or hardware modules, represented by the processor 822 (e.g., controller processor 390), the modules 802, 804, 806 (e.g., executable code stored in error handling module 391), and the non-transitory computer-readable medium 826 (e.g., memory 392 and error handling module 391). The bus 824 may also link various other circuits such as timing sources, peripherals, voltage regulators, and power management circuits, which are well known in the art, and therefore, will not be described any further.

The apparatus includes a processing system 814 coupled to a transceiver 830 (e.g., receiver 354, transmitter 356, and associated receive/transmit processors). The transceiver 830 is coupled to one or more antennas 820 (e.g., antenna 352). The transceiver 830 enables communicating with various other apparatus over a transmission medium. The processing system 814 (e.g., controller processor 390 and memory 392) includes a processor 822 coupled to a non-transitory computer-readable medium 826. The processor 822 is responsible for general processing, including the execution of software stored on the computer-readable medium 826. The software, when executed by the processor 822, causes the processing system 814 to perform the various functions described for any particular apparatus. The computer-readable medium 826 may also be used for storing data that is manipulated by the processor 822 when executing software.

The processing system 814 includes a receiving module 802 for receiving a message from a source base station connected to a first radio network controller to relocate to a target base station connected to a second network controller different from the first network controller. The processing system 814 also includes a detecting module 804 for detecting an unrecoverable Radio Link Control (RLC) error and an ignoring module 806. If the detecting module 804 detects the RLC unrecoverable error after receiving the message to relocate, while the apparatus 800 is still connected to the source base station/RNS, before relocation is completed, the ignoring module 806 will determine to ignore the error and instruct the processing system 814 to proceed to relocate to the target base station/RNS. The modules may be software modules running in the processor 822 (e.g., controller/processor 390), resident/stored in the non-transitory computer readable medium 826 (e.g., RLC error handling module 391 stored in memory 392), one or more hardware modules coupled to the processor 822, or some combination thereof. The processing system 814 may be a component of the UE 110/350 and may include the memory 392, and/or the controller/processor 390.

In one configuration, an apparatus such as a UE 110/350 is configured for wireless communication including means for receiving a message from a source base station connected to a first radio network controller to relocate to a target base station connected to a second network controller different from the first network controller. The means for receiving may be the antennas 352, the receiver 354, the channel processor 394, the receive frame processor 360, the receive processor 370, the controller/processor 390 executing program code stored in the memory 392 and/or RLC error-handling module 391, the receiving module 802, and/or the processing system 814 configured to perform the function of receiving a message at a user equipment (UE) from a source base station connected to a first radio network controller to relocate to a target base station connected to a second network controller different from the first network controller.

The UE is also configured to include means for detecting an unrecoverable Radio Link Control (RLC) error. The means detecting may reside in program code executed by the controller/processor 390 (including program code in the memory 392 and/or RLC error-handling module 391) (e.g., a program code component of the RLC layer), the detecting module 804, and/or the processing system 814 configured to perform the function of detecting an unrecoverable Radio Link Control (RLC) error at the UE.

The UE is also configured to include means for ignoring the RLC unrecoverable error when it occurs after receiving the message to relocate while the apparatus is still connected to the source base station, before relocation is completed, and proceeding to relocate to the target base station. The mean for ignoring may comprise program code executed by the controller/processor 390 (including program code in the memory 392 and/or RLC error-handling module 391, such as a program code component of the RLC layer, the RRC layer, or a higher-layer process),the ignoring module 806, and/or the processing system 814 configured to perform the function of ignoring the RLC unrecoverable error when it occurs after receiving the message to relocate while the UE is still connected to the source base station, before relocation is completed, and proceeding to relocate to the target base station.

Several aspects of a telecommunications system has been presented with reference to 3GPP in general, and to TD-SCDMA in particular. As those skilled in the art will readily appreciate, various aspects described throughout this disclosure may be extended to other telecommunication systems, network architectures and communication standards. By way of example, various aspects may be extended to other UMTS systems such as W-CDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a non-transitory computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of wireless communication, comprising:
receiving a message at a user equipment (UE) from a source base station connected to a first radio network controller to relocate to a target base station connected to a second network controller different from the first network controller;
detecting an unrecoverable Radio Link Control (RLC) error at the UE; and
ignoring the RLC unrecoverable error when it occurs after receiving the message to relocate while the UE is still connected to the source base station, before relocation is completed, and proceeding to relocate to the target base station.

2. The method of claim 1, in which the unrecoverable RLC error, if not ignored, results in entering an idle state or sending the source base station a cell update message.

3. The method of claim 2, in which the unrecoverable RLC error is detected during Acknowledged Mode (AM) operations within a Universal Terrestrial Radio Access Network (UTRAN).

4. The method of claim 3, in which the message from the source base station to relocate is a Source Radio Network Subsystem relocation message.

5. The method of claim 4, in which the unrecoverable RLC error is triggered by a number of uplink transmissions channels of the user equipment reaching or exceeding a maximum limit.

6. An apparatus for wireless communication, comprising:
means for receiving a message from a source base station connected to a first radio network controller to relocate to a target base station connected to a second network controller different from the first network controller;
means for detecting an unrecoverable Radio Link Control (RLC) error; and
means for ignoring the RLC unrecoverable error when it occurs after receiving the message to relocate while the apparatus is still connected to the source base station, before relocation is completed, and proceeding to relocate to the target base station.

7. The apparatus of claim 6, in which the unrecoverable RLC error, if not ignored, results in entering an idle state or sending the source base station a cell update message.

8. The apparatus of claim 7, in which the unrecoverable RLC error is detected during Acknowledged Mode (AM) operations within a Universal Terrestrial Radio Access Network (UTRAN).

9. The apparatus of claim 8, in which the message from the source base station to relocate is a Source Radio Network Subsystem relocation message.

10. The apparatus of claim 9, in which the unrecoverable RLC error is triggered by a number of uplink transmissions channels of the apparatus reaching or exceeding a maximum limit.

11. A computer program product configured for operation in a wireless communication network, the computer program product comprising a non-transitory computer-readable medium having program code recorded thereon, the program code comprising:
program code to receive a message from a source base station connected to a first radio network controller to relocate to a target base station connected to a second network controller different from the first network controller;
program code to detect an unrecoverable Radio Link Control (RLC) error; and
program code to ignore the RLC unrecoverable error when it occurs after receiving the message to relocate a user equipment while still connected to the source base station, before relocation is completed, and proceed to relocate to the target base station.

12. The computer program product of claim 11, in which the unrecoverable RLC error, if not ignored, results in entering an idle state or sending the source base station a cell update message.

13. The computer program product of claim 12, in which the unrecoverable RLC error is to be detected during Acknowledged Mode (AM) operations within a Universal Terrestrial Radio Access Network (UTRAN).

14. The computer program product of claim 13, in which the message from the source base station to relocate is a Source Radio Network Subsystem relocation message.

15. The computer program product of claim 14, in which the unrecoverable RLC error is triggered by a number of uplink transmissions channels of the user equipment reaching or exceeding a maximum limit.

16. An apparatus configured for operation of a user equipment (UE) in a wireless communication network, the apparatus comprising:
a memory; and
at least one processor coupled to the memory, the at least one processor being configured:
to receive a message from a source base station connected to a first radio network controller to relocate to a target base station connected to a second network controller different from the first network controller;
to detect an unrecoverable Radio Link Control (RLC) error; and
to ignore the RLC unrecoverable error when it occurs after receiving the message to relocate while the apparatus is still connected to the source base station, before relocation is completed, and proceed to relocate to the target base station.

17. The apparatus of claim 16, in which the unrecoverable RLC error, if not ignored, results in entering an idle state or sending the source base station a cell update message.

18. The apparatus of claim 17, in which the unrecoverable RLC error is detected during Acknowledged Mode (AM) operations within a Universal Terrestrial Radio Access Network (UTRAN).

19. The apparatus of claim 18, in which the message from the source base station to relocate is a Source Radio Network Subsystem relocation message.

20. The apparatus of claim 19, in which the unrecoverable RLC error is triggered by a number of uplink transmissions channels of the apparatus reaching or exceeding a maximum limit.
